(19) United States
(12) Patent Application Publication
(10) Pub. No.: US 2015/0239572 A1
(43) Pub. Date: Aug. 27, 2015

(54) APPARATUS AND METHODS FOR FRONT SURFACE MOUNTING FLAT PANEL DISPLAYS

(71) Applicant: Lawrence E. Tannas, JR., Orange, CA (US)

(72) Inventor: Lawrence E. Tannas, JR., Orange, CA (US)

(21) Appl. No.: 14/633,029

(22) Filed: Feb. 26, 2015

Related U.S. Application Data
(60) Provisional application No. 61/945,071, filed on Feb. 26, 2014.

(51) Int. Cl. B64D 43/00; H01R 43/00; B60R 11/02

(52) U.S. Cl. CPC B64D 43/00; B60R 11/0235; H01R 43/00

(57) ABSTRACT

Apparatus and methods are provided for mounting a flat panel display to an outer surface of a control panel, e.g., over a panel opening therein. In one embodiment, the method includes attaching a flange to the control panel by inserting fasteners through the flange into respective holes in the control panel; electrically connecting the FPD through openings in the flange and the control panel to electronics behind the control panel; inserting the FPD into a recess in the flange; and attaching a bezel to the flange to cover the FPD, the bezel including a view port allowing observation of an active image area of the display

### RELATED APPLICATION DATA

This application claims benefit of co-pending provisional application Serial No. 61/945,071, filed Feb. 26, 2014, the entire disclosure of which is expressly incorporated by reference herein.

### FIELD OF THE INVENTION

The present invention relates generally to electronic displays for displaying information, and to apparatus and methods for mounting a display to the front of a panel, such as a control panel within a cockpit of an aircraft, flight simulator, or work station.

### BACKGROUND

Control panels, e.g., provided within a cockpit of an aircraft or a flight simulator, include a plurality of panel openings for receiving instruments therein. FIG. 1A shows an exemplary panel opening 92 that may be provided in a control panel 90 and having an octagonal shape, e.g., a generally rectangular or square shape defined by vertical and horizontal sides 94 but with diagonal corners 96. Generally, holes 98 are provided adjacent the corners 96 for receiving screws or other fasteners therethrough.

Turning to FIG. 1B, an instrument 100 may be mounted in the panel opening 92, e.g., using screws 102 received through the holes 98 (not shown in FIG. 1B). As shown, the instrument 100 may have a round or other display 104 and a face plate 106 that abuts the control panel 90 when the instrument 100 is mounted. Typically, the display 104 cannot protrude forward from the control panel 90 more than a fraction of an inch so as not to interfere with or block the view and operation of other functions of the control panel 90, e.g., other displays (not shown) mounted adjacent the display 104.

Generally, the instrument 100 may include a long box (not shown) into which the dial 104 is mounted that extends through the panel opening 92 into the space behind the control panel 90. The box may include components for operating the instrument 100 and/or for receiving information and/or providing information to other parts of the aircraft. For example, the box may include a cathode ray tube (“CRT”) that provides an image to the dial 104, electronic circuits, mechanical components, and the like. Alternatively, the instrument 100, i.e., with the dial 104 mounted to the front of the box, may be mounted through the panel opening 92 from behind the control panel 90. For example, the dial 104 may be sufficiently small to extend through the opening 92, with the box and other portions of the instrument 100 secured to the back of the control panel 90 or otherwise behind the control panel 90.

More recently, flat panel displays (“FPDs”) have been suggested to replace older instruments, such as CRTs or mechanical gauges. Such displays, however, may not be made economically with the four corners removed or rounded, e.g., due to the external circuits extending along at least two edges of the displays. For example, if a square or rectangular display is to be mounted within a panel opening 92, the display must be smaller than the panel opening 92, which may substantially reduce the active image area of the display available for displaying information.

Consequently, flat panel displays are generally mounted behind the control panel 90 with the active area of the display visible through a viewport in the control panel 90, e.g., similar to the panel opening 92 but having a shape similar to the active area of the display. When some liquid crystal displays (LCDs) are introduced into the instrument assembly, however, problems often occur because more panel area is needed for the LCD footprint than previously allowed. For example, the same screw holes 98 in the control panel 90 (e.g., as shown in FIG. 1A) cannot be used because the screws would interfere with the footprint of the LCD. Furthermore, the LCD footprint is most often too large to pass through the panel opening 92 if assembled in the instrument assembly and attempted to be inserted into the control panel 90 from the front.

Accordingly, apparatus and methods for mounting a display to a control panel would be useful.

### SUMMARY OF THE INVENTION

The present invention is directed generally to electronic displays, e.g., to flanges, systems, and methods for mounting flat panel displays (“FPDs”), such as liquid crystal displays (“LCDs”) to a control panel, such as a cockpit panel within an aircraft or other vehicle, a flight simulator, or a work station.

Generally, a flange method is provided for mounting a flat panel display (FPD) on the front surface of a control panel where the FPD may partially cover the mounting holes and access hole used to attach and access the instrument assembly located on the back surface of the control panel. The instrument assembly may include a box containing the electronic interface for the display and external input signals. Unlike conventional displays, where the FPD is an integral part of the instrument assembly and mounted to the panel's back surface as a single assembly, the systems and methods herein allow the FPD to be a separate assembly mounted on the front surface of the control panel facilitated by a flange.

The flange and mounting sequence may allow for interchangeable and/or independent mounting of a FPD to a control panel. When positioned as desired on the control panel, the FPD may partially cover one or more of the instrument mounting holes. Further, the flange may allow for electrical and mechanical connections to be made between the instrument assembly behind the control panel and the FPD, bezel, lighting, switches, control shafts, etc., on the front of the control panel.

For example, in accordance with one embodiment, a method is provided for mounting a display, such as an LCD or other FPD, to a control panel that includes mounting a display to an outer surface of the control panel, e.g., over a panel opening in the control panel, directing one or more wires from the display through the control panel, and coupling the one or more wires to electronics behind the control panel. In one embodiment, a flange may be attached to the control panel, e.g., by inserting fasteners through the flange into respective holes in the control panel. The display may be electrically connected through one or more access holes in the flange and control panel to the electronics, and a display and bezel may be attached to the flange. For example, a display may be inserted into a recess in the flange, and a bezel may be attached to the flange, e.g., using one or more fasteners inserted through holes in the bezel into the flange, e.g., such a perimeter of the display is covered and an active area of the display is visible through an opening in the bezel.

Optionally, a box may be mounted behind the control panel, e.g., generally opposite to and/or independent of the display and/or other components. The box may include the electronics that may be coupled to the display, e.g., for operating the display and presenting desired information on the active area, e.g., based on external input signals.

Other aspects and features of the present invention will become apparent from consideration of the following description taken in conjunction with the accompanying drawings.

### BRIEF DESCRIPTION OF THE DRAWINGS

The drawings illustrate exemplary embodiments of the invention, in which:

FIG. 1A is a plan view of a panel opening in a control panel.

FIG. 1B is a plan view of an instrument received in the panel opening of the control panel of FIG. 1A.

FIG. 2A is an exploded perspective view of an exemplary apparatus for mounting an electronic display to a control panel, including a mounting flange, a flat panel display, and a bezel.

FIG. 2B is a front view of an exemplary display mounted to a control panel using a mounting flange and bezel.

FIG. 2C is a cross-section view of an exemplary display mounted to a front surface of a control panel using a mounting flange and bezel and an instrument box mounted to a back surface of the control panel.

FIG. 3 is a front view of an exemplary embodiment of a mounting flange.

FIG. 3A is a cross-sectional view of the flange of FIG. 3 taken along line 3A-3A.

FIG. 4 is a front view of an exemplary embodiment of a bezel.

FIG. 5 is an exploded perspective view of another exemplary apparatus for mounting an electronic display to a control panel, including a mounting flange, a flat panel display, a bezel, and a flangeless mounting bracket for mounting the assembly to an instrument box carrying electronics for operating the display.

FIG. 6 is a flowchart showing an exemplary method for mounting a flat panel display to a control panel.

### DETAILED DESCRIPTION OF THE EXEMPLARY EMBODIMENTS

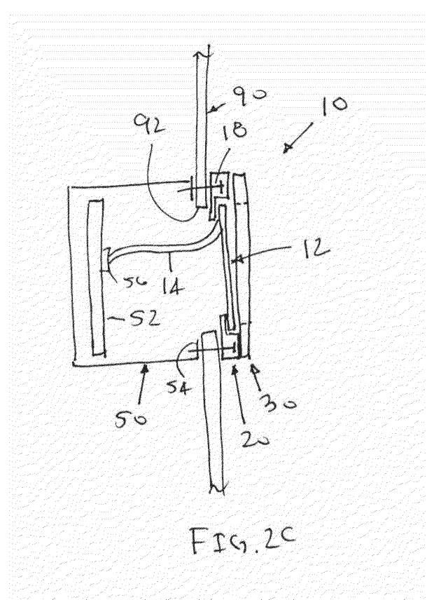

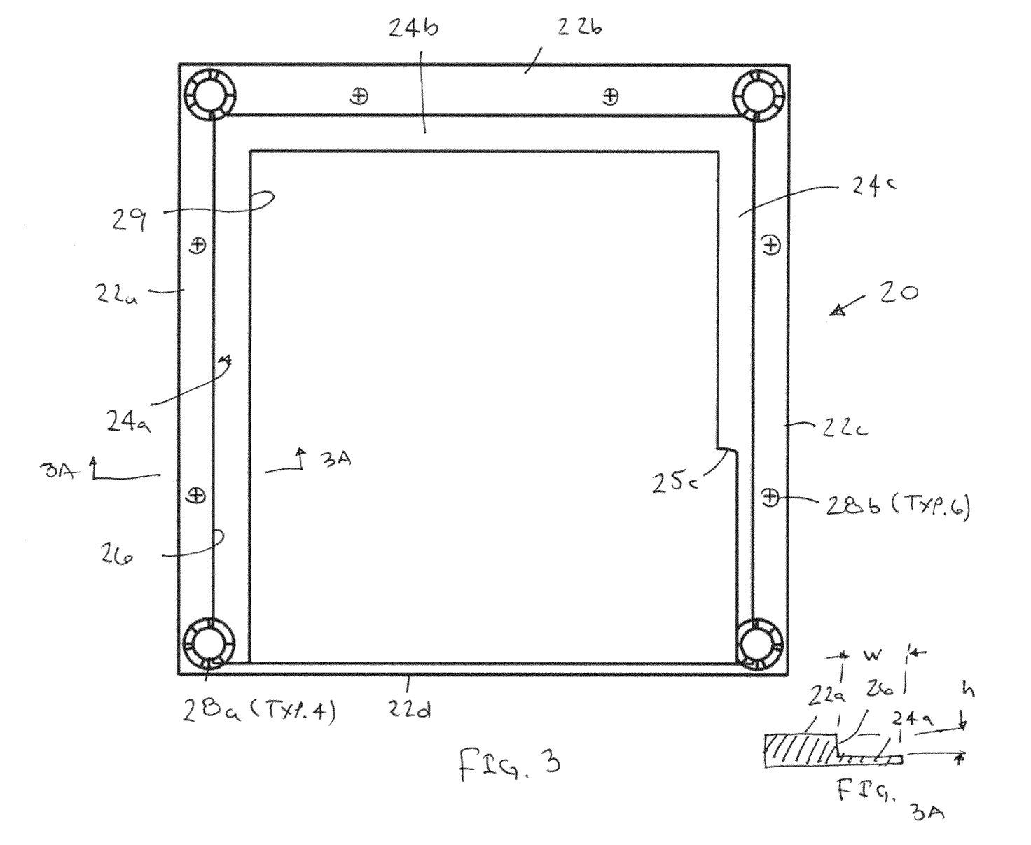

Turning to the drawings, FIGS. 2A-2C show an exemplary embodiment of an apparatus 10 for mounting a flat panel display (“FPD”) 12 to a control panel 90. Generally, the apparatus 10 includes a flange or other frame 20 for receiving the display 12, a bezel 30 for partially covering the display 12, and a plurality of fasteners, e.g., screws 18, for securing the display 12 and/or apparatus 10 to the front of the control panel 90. Optionally, the apparatus 10 may also include an instrument assembly 50, e.g., a box or casing including electronics 52 for operating the display 12 therein, which may be mounted to the back of the control panel 90, e.g., opposite the flange 20, as described elsewhere herein.

The display 12 may be a liquid crystal display (“LCD”), such as an active matrix liquid crystal display (“AMLCD”). Alternatively, the display 12 may be one of a variety of other types of electronic displays, such as plasma displays, liquid crystal on silicon (“LCOS”) displays, organic light-emitting diode (“OLED”) displays, electroluminescence displays, and the like. The display 12 may have a rectangular, square, or other size and/or shape, which may be larger than a cross-section of the panel opening 92 in the control panel 90, as explained further below. Optionally, the display 12 may be a resized display, i.e., a rectangular display that has been cut and resealed into a smaller configuration, e.g., a square or other configuration. Exemplary displays that may be used and methods for making them are disclosed in U.S. Pat. Nos. 6,204,906, 7,780,492, and 7,938,051, the entire disclosures of which are expressly incorporated by reference herein.

The display 12 may include one or more external circuits, e.g., TABs, COGs, driver circuits, and the like (not shown), extending along one or more edges of the display 12, e.g., as disclosed in the applications incorporated by reference herein. In an exemplary embodiment, the circuits may extend from a top edge and a side edge of the display 12 around to a back surface of the display 12, e.g., by folding flex circuits around the display 12, similar to FPDs used for laptop computers and other devices where it is desirable to minimize components extending outwardly from the top and/or side edges of the display 12. The circuit(s) on the display 12 may include one or more ribbon connectors, wires, or other cables (one cable 14 shown for simplicity), which may be used to couple the display 12 to the electronics 52 for operating the display 12, e.g., provided within the instrument assembly 50 behind the control panel 90, e.g., as shown in FIG. 2C.

Optionally, the display 12 may include other components, such as one or more polarizer films, filters, image enhancement films, and/or viewing angle enhancement films on front and/or back surfaces of the display 12, e.g., overlying an active image area 20 of the display 12. In addition or alternatively, the display 12 may include a backlight, e.g., a LED or other backlight (not shown) mounted to or folded onto the back of the display 12, one or more switches, dials, or other interface components (not shown).

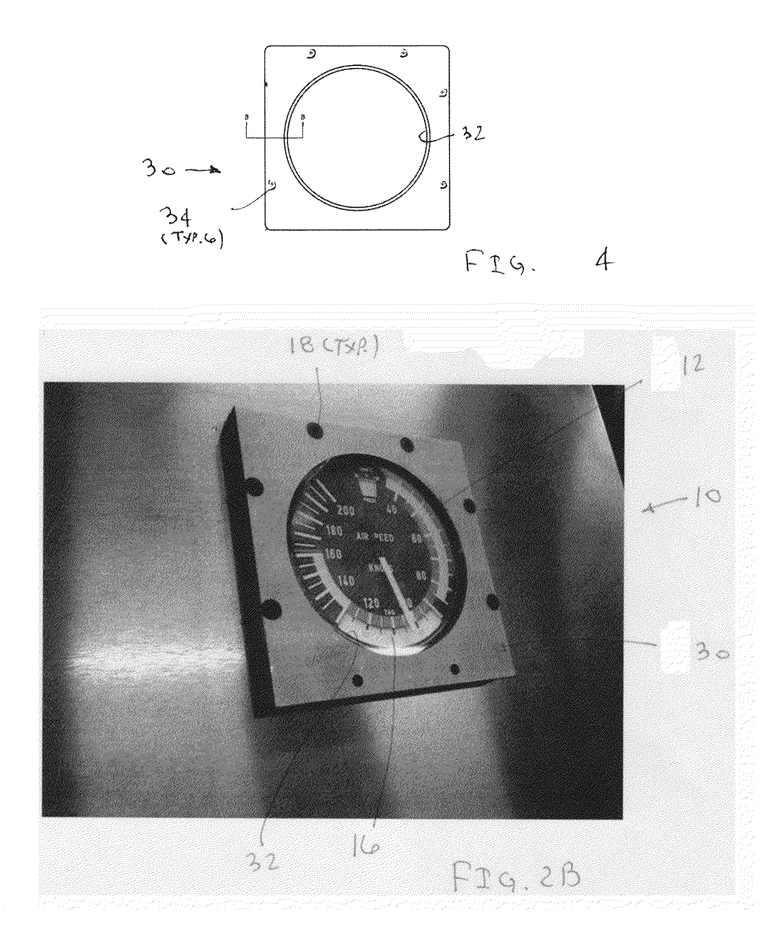

With continued reference to FIG. 2A and additional reference to FIG. 3, the flange 20 is a generally planar member defined by a plurality of side walls 22 and back walls 24, thereby defining a recess 26 for receiving the display 12 therein. The flange 20 and/or recess 26 may have a rectangular or square periphery, e.g. corresponding to the outer perimeter of the display 12, although alternatively, the flange 20 may have an elliptical or round outer periphery (not shown), if desired, based on the available space and/or configuration of the control panel 90.

The back walls 24 may define a back plane of the flange 20, which may be substantially flat and/or otherwise shaped to be placed against and/or correspond to the shape of the outer surface of the control panel 90. The back walls 24 generally define an opening 29 through the flange 20, which may be large enough to accommodate directing one or more cables through the flange 20, e.g., for directing the cable(s) 14 from the display 12 through the panel opening 92 to the instrument assembly 50, as described further elsewhere herein. The back walls 24a-24c may have sufficient width to support the display 12 and/or prevent the display 12 from falling through the opening 29. For example, as shown in FIG. 3A, the back walls 24a-24c may have widths “w” between about one and ten millimeters (0.04-0.4 inch).

The side walls 22 may extend outwardly from the back plane to define sides of the recess 26, e.g., such that the sides of the display 12 are disposed immediately adjacent the side walls 22 when positioned in the recess 26 to support the display 12 with minimal lateral movement. In an exemplary embodiment, as indicated in FIG. 3A, the side walls 22 may have a height “h” above the back walls 24, e.g., between about one and ten millimeters, corresponding to an overall thickness of the display 12 (and any circuits behind the display 12) to be received within the recess 26.

In the exemplary embodiment shown, three of the side walls 22a-22c include back walls 24a-24c, while a fourth side wall 22d does not include a back wall, e.g., such that the recess 26 has a rectangular shape while the outer periphery of the flange 20 has a substantially square shape. This configuration may allow an active area of the display 12 received in the recess 26 to be centered within the flange 20, e.g., if the display 12 includes circuits along one side thereof, which may be positioned adjacent side wall 22d. In addition or alternatively, one or more of the back walls 24 may include notches or other features to accommodate components of the display 12. For example, as shown, back wall 24c includes a notch 25c, which may accommodate a backlight or other component (not shown) of the display 12 that will be positioned adjacent the back wall 24c. Thus, the notch 25c may accommodate a relatively thicker region of the display 12, thereby allowing the display 12 to lie substantially flat within the recess 26, e.g., with the outer surface of the display 12 substantially parallel to the back plane of the back walls 24. In addition, as best seen in FIG. 3, the flange 20 includes a plurality of fastener holes 28 for receiving respective fasteners therethrough, e.g., screws, rivets, bolts, pins, and the like (not shown). For example, a first set of fastener holes 28a may be provided around a periphery of the flange 20 in a desired pattern, e.g., formed through the side walls 24 corresponding to the existing pattern of holes 98 in the control panel 90 around the panel opening 92. The fastener holes 28a may be countersunk or otherwise formed such that heads of fasteners 18 inserted into the fastener holes 28a do not extend above the side walls 22, e.g., as shown in FIG. 2C Although four fastener holes 28a are shown, it will be appreciated that fewer or additional fastener holes 28a may be provided, e.g., two, three, or more on the flange 20, if desired or the existing control panel dictates. Alternatively, a plurality of fasteners (not shown) may be attached to the flange 20, e.g., such that the fasteners extend through the fastener holes 28a and may be rotated, as needed to thread the fasteners into the holes 98 in the control panel 90, e.g., as described elsewhere herein.

In addition, a second set of fastener holes 28b may be provided around the periphery of the flange 20 in a desired pattern, e.g., corresponding to fastener holes 34 in the bezel 30. The fastener holes 28b may extend entirely or only partially through the side walls 22, as desired to accommodate fasteners from the bezel 30.

The flange 20 may be formed from a flat sheet of material, e.g., a relatively thin sheet of metal, such as aluminum or stainless steel, plastic, or a composite material. In exemplary embodiments, the flat sheet may be cut, machined, cast, molded, or otherwise formed into the desired shape including the side walls 22 and back walls 24. The fastener holes 28 and/or any other desired openings (not shown) may be cut, drilled, integrally molded, or otherwise formed in the flange, as desired.

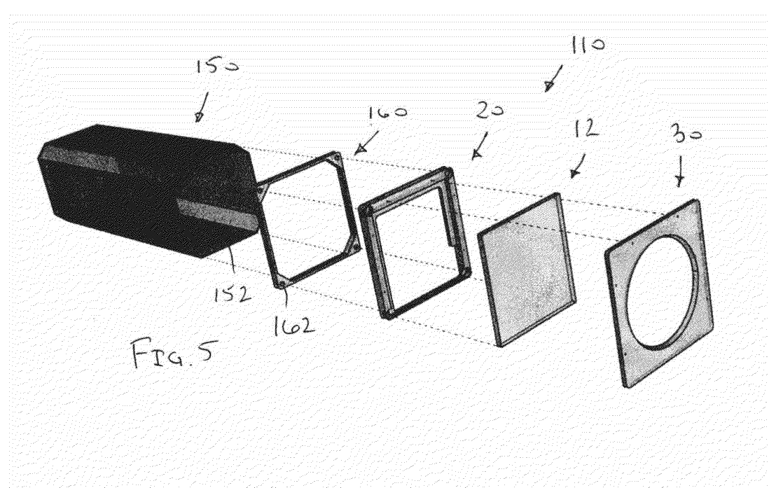

With continued reference to FIGS. 2A and 2B and additional reference to FIG. 4, the bezel 30 may also be a generally planar member including an outer perimeter or border generally defining a rectangular or square shape. The bezel 30 may include a viewing hole or opening 32 therein, e.g., to allow an active image area 16 of the display 12 to be seen therethrough, as shown in FIG. 2B. The size of the bezel 30 and opening 32 may be selected to mask inactive areas around the perimeter of the display 12 and/or to cover any components on the periphery of the display 12. Optionally, a bezel may be provided that includes several viewing holes or openings (not shown) such that a single bezel may be used to cover multiple displays mounted to the front surface of a control panel, e.g., using separate flanges or a single large flange including multiple recesses for respective displays (also not shown).

Returning to FIG. 4, the bezel 30 may include one or more fastener holes 34 provided around the opening 32, e.g., corresponding to fastener holes 28b in the flange 20. Alternatively, the bezel 30 may include a plurality of fasteners (not shown) attached to the bezel 30 at the locations of the fastener holes 34, e.g., such that the fasteners extend through the fastener holes 34 and may be rotated, as needed to thread the fasteners into the corresponding fastener holes 28b in the flange 20, as described elsewhere herein. Optionally, the bezel 14 may include one or more switches, dials, or other components (not shown) useful for operating the display 12 received therein.

Similar to the flange 20, the bezel 30 may be formed from metal, plastic, or composite materials, e.g., that may be cut, machined, or otherwise formed from a flat sheet, cast, injection molded, and the like. As best seen in FIG. 2B, the bezel 30 may have an outer perimeter similar in size and/or shape to the outer periphery of the flange 20, e.g., to provide a flush finish when mounted to a control panel 90.

Turning to FIG. 2C, optionally, the apparatus 10 may also include an instrument assembly 50 carrying electronics 52 for operating the display 12 and/or for communicating between the display 12 and other devices, e.g., for receiving input signals that are processed and used to display information on the display 12. For example, the electronics 52 may provide input and output signal processing for the display 12 and/or other devices with which the display 12 communicates, operator input capabilities, electronic information display, and the like. The instrument assembly 50 may include any package for carrying and/or enclosing the electronics 52, e.g., a tubular body, box, and the like, as is well known in the art.

Optionally, the instrument assembly 50 may include one or more flanges 56 for mounting the instrument assembly 50 to the control panel 90, e.g., to the back surface of the control panel 90 behind the panel opening 92. In one embodiment, the flanges 56 may include holes (not shown) for receiving fasteners 18 therethrough. The fasteners 18 may also be used for mounting the flange 20 to the control panel 90, as shown, or separate fasteners (not shown) may be used.

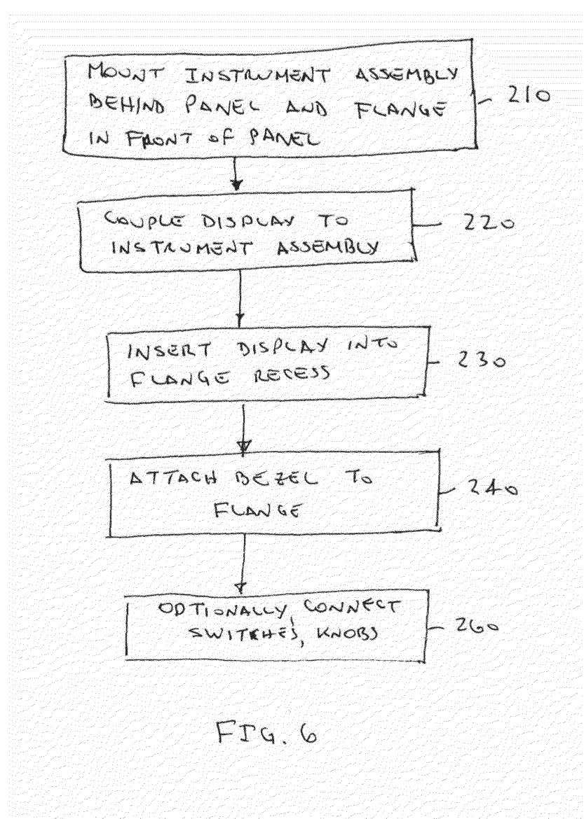

Alternatively, as shown in FIG. 5, an instrument assembly 150 may be provided that may be inserted through the panel opening 92 from the front or rear of the control panel 90. In this alternative, the instrument assembly 150 may include a tubular box mounted behind the control panel 90, e.g., using a clamp apparatus (not shown) around the instrument assembly 150 and/or using other known connection/mounting systems. In this alternative, a flangeless mounting bracket 160 may be provided that may be secured to one end 152 of the instrument assembly 150, e.g., by receiving the end 152 in slots (not shown) in the bracket 160 or using other interference fit or connectors. The bracket 160 may provide a plurality of fastener holes 162 for receiving fasteners (not shown) used to mount the flange 20 to the bracket 160.

Returning to FIGS. 2A-2C, the apparatus 10 may be used to mount a flat panel display 12 to a front surface of a control panel 90. The control panel 90 may be located within a cockpit of an aircraft or on the dashboard of another vehicle. Alternatively, the control panel 90 may be part of a flight simulator or a work station (not shown).

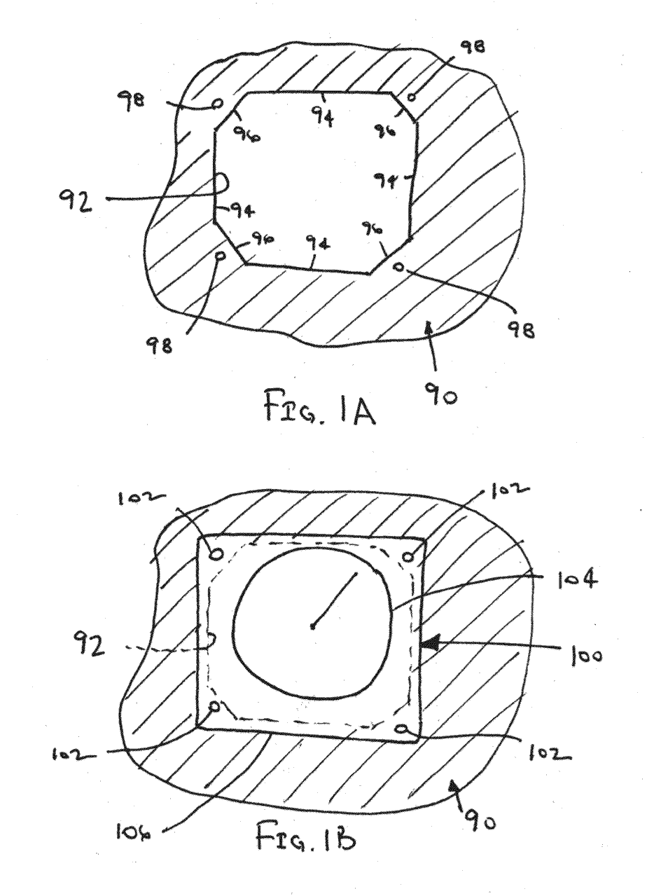

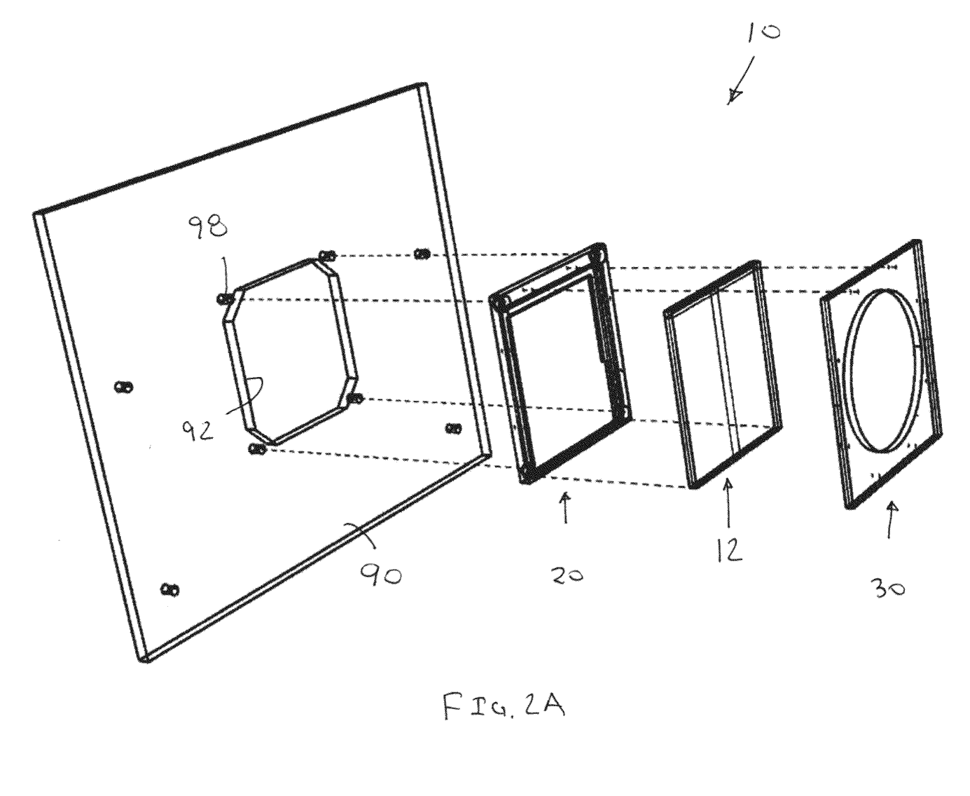

The apparatus 10 may be used to retrofit or replace an existing display (not shown) with the display 12 or for mounting a display 12 for the first time to the control panel 90. For example, as shown in FIG. 1B, an instrument 100 may already be mounted to the control panel 90 through the panel opening 92. The instrument 100 may include a CRT or gauge that has discontinued to function or is simply being upgraded to an LCD or other FPD. The instrument 100 may be removed from the control panel 90, e.g., by removing fasteners 102 and then pulling the instrument 100 from the panel opening 92 and away from the control panel 90. For example, an existing instrument may include a display that is inserted into the panel opening 92 from behind the control panel 90, and the existing instrument may have to be pulled back out of the panel opening 92 from behind, e.g., because the box or other components of the existing instrument are to large to be pushed out of the panel opening 92. Pulling the instrument 100 may also require disconnecting or severing cables or mechanical connectors (not shown) that are coupled to the instrument 100.

Turning to FIG. 6, an exemplary method is shown for mounting a flat panel display to a control panel, e.g., similar to any of the embodiments described elsewhere herein. Although a particular exemplary sequence is shown and described, it will be appreciated that the steps may be performed in a different order, as desired.

First, at step 210, an instrument assembly may be mounted behind the control panel and a flange (without display or bezel) may be mounted in front of the control panel. For example, with additional reference to FIGS. 2A-2C, the instrument assembly 50 may positioned adjacent a back surface of a control panel 90 and a flange 20 may positioned adjacent a front surface of the control panel 90, e.g., aligned with a panel opening 92. A plurality of screws or other fasteners 18 may be inserted through holes 28a in the flange 28, through corresponding holes 98 in the control panel 90, and into corresponding holes in flanges of the instrument assembly 50. Thus, in this embodiment, the flange 28 and instrument assembly 50 may be secured to the control panel 90 substantially simultaneously.

Alternatively, the flange 28 and instrument assembly 50 may be secured relative to the control panel 90 independent of one another. For example, the fasteners 18 may be used to secure the flange 28 to the control panel 90, e.g., using existing mounting holes 98, and the instrument assembly 50 may be mounted using a clamp or other connection system (not shown). Thus, in this alternative, the flange 28 may be secured before or after mounting the instrument assembly 50.

Next, at step 220, a display 12 may be coupled to the instrument assembly 50. For example, the display 12 may be positioned adjacent the flange 289 in front of the control panel 90, and one or more cables, e.g., a ribbon connector 14 may be directed from the display 12, through the opening 29 in the flange 28 and the panel opening 92 to the instrument assembly 50. In an exemplary embodiment, the instrument assembly 50 may include an electrical connector 56 and the ribbon connector 14 may include a mating connector to electrically couple the display 12 to the electronics 52. Alternatively, one or more wires or cables may be directed from the instrument assembly 50 through the openings 29, 92 and coupled to a mating connector (not shown) on the display 12.

Next, at step 230, the display 12 is inserted into the recess 26 in the flange 20. For example, the display 12 may be oriented to present the active area 16 of the display 12 outwardly and/or otherwise positioned within the recess 26, e.g., to center the active area 16 and/or position any circuits on the display 12 within the recess 26 behind the display 12. Optionally, the flange 20 may include one or more detents or other connectors (not shown) to engage the display 12 within the recess 26. For example, one or more of the side walls 22 may include tapered tabs or detents (not shown) that allow the display 12 to enter the recess 26 and then snap over a front of the display 12 to secure the display 12 within the recess 26. Optionally, other mechanical or electrical connections between the display 12, the flange 28, and/or the instrument assembly 50 may be completed at this stage.

Next, at step 240, the bezel 30 is attached to the flange 20 over the display 12. For example, the back surface of the bezel 30 may be placed against the outer surface of the flange 20, i.e., over the side walls 22, and one or more fasteners 18 may be inserted through the bezel 30 into the flange 20, as shown in FIG. 2B. For example, a plurality of screws 18 may be inserted through respective fastener holes 34 in the bezel 30 and threaded into respective fastener holes 28b in the flange 20. Alternatively, the display 12 may be secured to the bezel 30 before the bezel 30 is secured to flange 20.

As described elsewhere herein, the bezel 30 includes a view port or opening 32 through which the active area 16 of the display 12 may be observed, while covering the surrounding area of the display 12 and/or preventing exposure or access to circuits or other components of the display 12. As shown in FIGS. 2B and 2C, the bezel 30 may cover the fasteners 18 used to mount the flange 20 to the control panel 90, while the fasteners 18 used to mount the bezel 30 to the flange 20 may remain visible.

Optionally, at step 260, one or more switches, knobs, and/or other actuators or interface components (not shown) may be coupled to the resulting apparatus 10. For example, the display 12 may include one or more interface components on its front face and the bezel 30 may include corresponding openings (not shown) through which the interface components, e.g., hubs, pins, or other features may be accessed or extend. Any switches, knobs, and the like (also not shown) may be mechanically and/or electrically connected to the features, thereby allowing a user to perform various functions using the interface components.

At this point, the display 12 may be securely mounted to the front of the control panel 90 by the flange 20 and bezel 30 and operated in its normal intended manner. As shown in FIGS. 2B and 2C, the flange 20, display 12, and bezel 30 may all lie substantially flat, e.g., substantially parallel to the control panel 90 and project a relatively small distance above the surface of the control panel 90 in the final installation. With the display 14 being a FPD, the profile of the installation may be substantially minimized. For example, the display 12 may extend not more than about thirty millimeters (30 mm) or even less than about ten millimeters (10 mm) above the control panel 90 when the display 12 is secured to the control panel 90.

Optionally, the apparatus 10 and methods herein may allow a display 12 that has a size larger than the maximum cross-sectional dimension of the panel opening 92 to be secured to the control panel 90, thereby maximizing the active image area that may be used to provide information. Thus, the size of the display 12 may consequently be dictated, not by the size of the panel opening 92, but by the proximity of the display 12 to other displays or instruments mounted to the control panel 90 near the panel opening 92.

Another advantage of the apparatus 10 described herein is that it may reduce the cost to repair or replace the display 12 after installation. For example, with prepackaged instruments, if the instrument fails, the entire instrument is generally replaced. With the apparatus 10, it may only be necessary to repair or replace one or more components of the apparatus 10 after installation. For example, if the display 12 fails to operate at any time after installation, the display 12 and/or instrument assembly 50 may be tested. If only one of the display 12 and instrument assembly 50 need repair or replacement, the other components may remain in place.

To remove and/or replace the display 12, the process described above may be performed in reverse order.

As an example, a flange and bezel may be used to mount a 3ATI ARINC Standard 408A instrument, e.g., as shown in FIGS. 2A-2C. An LCD FPD is resized from a Mitsubishi 5″ LCD. The LCD is electrically driven via an electrical cable connection to facilitate using a Westar VP7 Controller Circuit Board located behind the panel. The LCD would not fit in the ARINC suggested maximum 3ATI bezel size if it were not resized. Even after resizing the Mitsubishi 5″ LCD, ARINC Standard 408A for a 3ATI instrument specifications prevent the installation of the LCD to the panel given prior nominal installation methods. Resizing the FPD is not an essential element of this systems and methods herein. However, resizing an FPD enables more optimum design options as is exhibited here with the resized Mitsubishi 5″ LCD. Exemplary systems and methods for resizing displays are disclosed in U.S. Pat. Nos. 6,204,906, 7,780,492, 7,938,051, and 8,259,282. Additional information regarding methods for mounting displays to panels are disclosed in U.S. Pat. No. 7,708,233. The entire disclosures of these references are expressly incorporated by reference herein.

It will be appreciated that elements or components shown with any embodiment herein are exemplary for the specific embodiment and may be used on or in combination with other embodiments disclosed herein.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

I claim:

1. A method for assembling a flat panel display (FPD) on a front surface of a control panel including a plurality of holes for receiving fasteners, the method comprising:
attaching a flange to the control panel by inserting fasteners through the flange into respective holes in the control panel;
electrically connecting the FPD through openings in the flange and the control panel to electronics behind the control panel;
inserting the FPD into a recess in the flange; and
after inserting the FPD into the recess, attaching a bezel to the flange to cover the FPD, the bezel including a view port allowing observation of an active image area of the display.

2. The method of claim 1, wherein the FPD comprises one of a liquid crystal, OLED, plasma, or electroluminescence display.

3. The method of claim 1, wherein the bezel comprises one or more switches or knobs to control the FPD.

4. The method of claim 1, wherein the FPD may be attached to the bezel before attaching both to the flange.

5. The method of claim 1, wherein the bezel is attached to the flange by inserting a plurality of fasteners through respective holes in a face of the bezel into respective holes in the flange.

6. The method of claim 1, wherein the flange comprises a plurality of side walls surrounding the recess to define a substantially rectangular recess and wherein the FPD is inserted into the recess such that an active area of the FPD is substantially centered in the flange.

7. The method of claim 6, wherein a plurality of back walls extend from the side walls to define a back surface of the recess and the opening through the flange.

8. The method of claim 1, further comprising mounting an instrument assembly behind the control panel, the instrument assembly carrying the electronics.

9. The method of claim 8, wherein the instrument assembly comprises a box and wherein the instrument assembly is mounted by inserting the fasteners inserted through the flange into the respective holes in the control panel and into respective holes in the box.

10. The method of claim 8, wherein the instrument assembly is mounted to a back surface of the control panel independent of the flange.

11. A method for assembling a flat panel display (FPD) on a front surface of a control panel where the FPD footprint is larger than an instrument hole in the control panel, the method comprising:
attaching a flange to the panel;
electrically connecting the FPD with one or more cables through a coincident hole in the panel and flange to an instrument assembly mounted behind the control panel;
attaching the FPD to the flange; and
attaching the bezel to the flange to cover the FPD, the bezel including a view port allowing observation of an active image area of the display.

12. A method for assembling a flat panel display (FPD) on a front surface of a control panel where the FPD is assembled separately from associated instrument electronics on a back surface of the control panel, comprising:
attaching a flange to the front surface of the panel;
electrically connecting the FPD to the instrument electronics via one or more electrical cables;
attaching the FPD to the flange; and
attaching the bezel to the flange to cover the FPD, the bezel including a view port allowing observation of an active image area of the display.
